(19) United States
(12) Patent Application Publication
(10) Pub. No.: US 2016/0136839 A1
(43) Pub. Date: May 19, 2016

(54) A LOG SPLITTER, AND A METHOD FOR SPLITTING A LOG

(71) Applicant: Bernard Michael CONROY, Ballinasloe (IE)

(72) Inventor: Bernard Michael CONROY, Ballinasloe (IE)

(21) Appl. No.: 14/899,611

(22) PCT Filed: Jun. 23, 2014
(86) PCT No.: PCT/IE2014/000013

§ 371 Date: Dec. 18, 2015

(30) Foreign Application Priority Data
Jun. 21, 2013 (IE) S2013/0201

(51) Int. Cl. B27L 7/00

(52) U.S. Cl. CPC B27L 7/00

(57) ABSTRACT

A log splitter (1) for coupling to a dipper arm (2) of an earth working machine comprises a support element (3) and an anvil (5) extending perpendicularly from the support element (3). A splitting element (6) is slideable longitudinally along the support element (3) from a receiving state spaced apart from and defining with the anvil (5) an open mouth (9) for receiving a log, and a splitting state adjacent the anvil (5) for splitting the log. A primary ram (7) coupled between the splitting element (6) and a mounting bracket (20) extending from the support element (3) urges the splitting element (6) between the receiving and splitting states. A mounting element (10) couples the log splitter (1) to the dipper arm (2) and is pivotally coupled to the support element (3) by a main pivot shaft (45), so that the support element (3) is pivotal about the main pivot shaft (45) through an angle of 95° relative to the mounting bracket (10) from a first state with the open mouth (9) facing in a first direction, and a second state with the open mouth (9) facing in a second direction perpendicular to the first direction, thereby permitting the log splitter (1) to engage horizontally or vertically disposed logs or logs inclined to the vertical for splitting thereof.

The present invention relates to a log splitter, and in particular, to a log splitter for coupling to a working arm, for example, a dipper arm of a prime mover, such as an earth working machine. The invention also relates to a working arm of a prime mover comprising the log splitter coupled thereto, and the invention also relates to a prime mover comprising a working arm with the log splitter attached to the working arm. Further the invention relates to a method for splitting a log with the log splitter.

Log splitters for splitting logs which are suitable for mounting to a prime mover, for example, an earth working machine, a tractor or the like are known. Such a log splitter is disclosed in U.S. Pat. No. 5,803,141 of Patterson, where a log splitter is adapted for mounting to a working arm, namely, a dipper arm of an earth working machine. In the log splitter disclosed in U.S. Pat. No. 5,803,141, the log splitter is coupled to the dipper arm by a vertically extending shaft. The shaft is rigidly connected to the log splitter, and is rotatably carried in a mounting system attached to the dipper arm. A drive motor rotates the shaft for rotating the log splitter about a vertical axis. The log splitter comprises an elongated horizontally extending support element which is rigidly mounted on the lower end of the vertically extending shaft. A splitter blade extends downwardly from one end of the support element, and an anvil is urged by a ram along the support element towards the splitting element for urging a log into engagement with the splitting element for splitting the log. However, the log splitter disclosed in U.S. Pat. No. 5,803,141 is suitable only for splitting logs which are lying horizontally on the ground with the grain of the log lying horizontally.

There is therefore a need for a log splitter which is suitable for picking up a log and for splitting a log, irrespective of the orientation of the log or the direction of the grain of the log in its rest state when lying on the ground or lying in a pile of logs.

The present invention is directed towards providing such a log splitter. The invention is also directed towards providing a working arm of a prime mover comprising the log splitter mounted thereon. Additionally, the invention is directed towards a prime mover comprising a working arm and the log splitter mounted on the working arm. Further, the invention is directed towards a method for splitting a log with the log splitter.

According to the invention there is provided a log splitter comprising a support element, an anvil supported on the support element, a splitting element supported on the support element, one of the splitting element and the anvil being moveable from a receiving state with the splitting element and the anvil spaced apart from each other and defining an open mouth therebetween for receiving a log, towards the other one of the splitting element and the anvil to a splitting state with the splitting element and the anvil co-operating with each other to split the log, a drive means for urging the moveable one of the splitting element and the anvil between the receiving state and the splitting state, a mounting means configured for mounting the support element to a working arm of a prime mover, the support element being pivotally coupled to the mounting means about a main pivot axis, and being pivotal about the main pivot axis relative to the mounting means between a first state with the open mouth defined between the splitting element and the anvil facing in a first direction, and a second state with the open mouth defined between the splitting element and the anvil facing in a second direction, the second direction extending at an angle greater than zero relative to the first direction, and an urging means for urging the support element relative to the mounting means about the main pivot axis between the first state and the second state.

In one embodiment of the invention the angle at which the second direction extends relative to the first direction is at least 45°. Preferably, the angle at which the second direction extends relative to the first direction is at least 90°. Advantageously, the angle at which the second direction extends relative to the first direction is approximately 95°.

In another embodiment of the invention the support element is pivotal about the main pivot axis from the first state to the second state through an angle greater than zero relative to the mounting means. Preferably, the support element is pivotal about the main pivot axis from the first state to the second state through an angle of at least 45° relative to the mounting means. Advantageously, the support element is pivotal about the main pivot axis from the first state to the second state through an angle of at least 90° relative to the mounting means. Ideally, the support element is pivotal about the main pivot axis from the first state to the second state through an angle of approximately 95° relative to the mounting means.

Preferably, the support element is pivotal about the main pivot axis relative to the mounting means through a plurality of intermediate states between the first and second states.

In one aspect of the invention the anvil extends in a leading direction from the support element and terminates in a distal leading edge spaced apart from the support element, the open mouth defined between the splitting element and the anvil facing generally in the leading direction from the support element.

In another aspect of the invention the support element comprises an elongated support element.

Preferably, the main pivot axis extends in a direction substantially transversely relative to the support element, and substantially transversely relative to the leading direction from which the anvil extends from the support element.

In another aspect of the invention the mounting means is adapted for coupling to a coupling element of a working arm of a prime mover. Preferably, the mounting means is adapted for coupling to a coupling element of a working arm of a prime mover, the coupling element of the working arm of the prime mover being pivotally coupled to the working arm about a coupler pivot axis, and the mounting means is configured for coupling to the coupling element with the coupler pivot axis extending in a direction substantially perpendicularly to the main pivot axis, and substantially parallel to the leading direction from which the anvil extends from the support element. Advantageously, the mounting means comprises a mounting element configured to carry a coupling member adapted for engagement by a coupling element of a working arm of a prime mover.

Preferably, the coupling member is configured for releasable engagement by a quick release mechanism of a coupling element of a working arm of a prime mover.

In one aspect of the invention the mounting element comprises a mounting plate.

In another aspect of the invention the anvil is rigidly mounted on the support element.

In a further aspect of the invention the splitting element is moveable between the receiving state and the splitting state longitudinally along the support element.

In one embodiment of the invention a guide means is provided for guiding the splitting element between the receiving state and the splitting state. Preferably, the guide means is mounted on the support element. Advantageously, the splitting element is slideably engageable with the guide means.

In another embodiment of the invention the splitting element comprises a splitter blade. Preferably, the splitter blade extends in a direction substantially parallel to the leading direction from which the anvil extends from the support element. Advantageously, the splitter blade extends in a direction substantially perpendicular to the main pivot axis.

In another aspect of the invention the splitter blade terminates in a cutting edge. Preferably, the cutting edge of the blade extends in a direction from the support element substantially parallel to the leading direction from which the anvil extends from the support element, and at an acute angle relative to the support element towards the anvil.

In one embodiment of the invention the drive means is operably coupled between the support element and the splitting element.

Preferably, the drive means is selectively and releasably coupleable to the support element in an operative state. Advantageously, the drive means when released from the support element is moveable between the operative state and an inoperative state.

In another aspect of the invention the drive means comprises a primary hydraulic ram.

In a further aspect of the invention the urging means is operably coupled between the mounting means and the support element. Preferably, the urging means comprises a secondary hydraulic ram.

In one embodiment of the invention the anvil adjacent the leading edge thereof tapers towards the leading edge for engaging between a log and a surface on which the log is supported. Preferably, the anvil defines an inner major surface facing towards the splitting element, and an opposite outer major surface facing away from the splitting element, the outer major surface being chamfered adjacent the leading edge of the anvil to form the tapering portion of the anvil adjacent the leading edge.

In another embodiment of the invention a projecting element extends sidewardly from the anvil adjacent one side thereof for engaging and manoeuvring a log. Preferably, the projecting element tapers towards a distal end thereof.

In another embodiment of the invention a support member is provided extending sidewardly from at least one side of the support element for supporting a log in the log splitter when the log splitter is oriented with the open mouth defined between the splitting element and the anvil facing in a generally upwardly direction. Preferably, a pair of support members are provided on respective opposite sides of the support element. Advantageously, each support member is releasably coupleable to the support element.

In one aspect of the invention each support member is mounted on a framework which is releasably coupleable to the support element.

In another aspect of the invention a manual control means is provided for manually controlling the drive means. Preferably, the manual control means comprises a safety interlock system, the safety interlock system being configured so that the two hands of an operator are required to manually operate the drive means through the manual control means.

In a further aspect of the invention the distance of travel of the moveable one of the splitting element and the anvil from the other one of the splitting element and the anvil to the receiving state is selectable.

Additionally, the invention provides a working arm of a prime mover, the working arm comprising the log splitter according to the invention, the log splitter being coupled to the working arm by the mounting means.

In one embodiment of the invention the working arm terminates in a coupling element, and the mounting means is coupled to the coupling element.

Preferably, the mounting means is releasably coupleable to the coupling element.

In one embodiment of the invention the coupling element is pivotally coupled to the working arm, and is pivotal about a coupler axis relative to the working arm, the coupler axis extending in a direction substantially perpendicular to the main pivot axis and substantially parallel to the leading direction from which the anvil extends from the support element.

In another embodiment of the invention the working arm comprises a dipper arm, and the coupling element is pivotally coupled to the dipper arm about the coupler pivot axis.

Further the invention provides a prime mover comprising a working arm according to the invention.

Preferably, the drive means and the urging means are powered by an on board power system of the prime mover.

Additionally the invention provides a method for splitting a log, the method comprising providing a log splitter according to the invention, coupling the log splitter to a working arm of a prime mover by coupling the mounting means to a coupling element of the working arm, operating the working arm for urging the log splitter towards a log to be split until the log is located in the open mouth defined between the splitting element and the anvil, and operating the drive means of the log splitter for urging the moveable one of the splitting element and the anvil from the receiving state to the splitting state for splitting the log.

In one embodiment of the invention the urging means of the log splitter is operated for pivoting the support element about the main pivot axis relative to the mounting means to orient the open mouth defined between the splitting element and the anvil to face towards a log to be split.

In another embodiment of the invention the urging means of the log splitter is operated for pivoting the support element about the main pivot axis relative to the mounting means for configuring the anvil for engaging beneath the log and between the log and the surface on which the log is supported.

In another embodiment of the invention the urging means of the log splitter is operated for urging the support element from one of the first state and the second state to one of the intermediate states for configuring the anvil for engaging beneath the log between the log and the surface on which the log is supported.

In a further embodiment of the invention the coupling element of the working arm is pivoted about the coupler pivot axis relative to the working arm for orienting the log splitter with the open mouth defined between the splitting element and the anvil facing in a generally upwardly direction for facilitating manual feeding of a log into the open mouth defined between the splitting element and the anvil.

Preferably, the drive means of the log splitter is manually controlled when the log splitter is oriented with the open mouth defined between the splitting element and the anvil facing in a generally upwardly direction.

The advantages of the invention are many. A particularly important advantage of the invention is that the log splitter can pick up a log in the open mouth defined between the splitting element and the anvil irrespective of the orientation in which the log is lying on the ground, in a pile of logs or lying or supported elsewhere, and furthermore, the log is picked up and engaged in the open mouth of the log splitter with the grain of the log correctly aligned with the splitting element, so that the log can be immediately split without requiring any further manoeuvring of the log in the open mouth. This advantage is achieved by virtue of the fact that the support element is pivotally coupled to the mounting means about the main pivot axis, and is pivotal about the main pivot axis relative to the mounting means between a first state with the open mouth defined between the splitting element and the anvil facing a first direction, and a second state with the open mouth defined between the splitting element and the anvil facing in a second direction, whereby the second direction extends at an angle greater than zero relative to the first direction. Accordingly, there is no need to manoeuvre the log prior to picking up of the log by the log splitter, and once picked up, there is also no need to manoeuvre the log in the open mouth of the blade splitter. This leads to significant time saving and manpower saving.

Another advantage of the invention is that the anvil can be engaged beneath a log and between the log and the surface on which the log is standing irrespective of the orientation of the log or the surface on which the log is standing.

Another advantage of the log splitter according to the invention is that an earth working machine to which the log splitter is attached can be driven along a public road while the log splitter is still attached to the dipper arm. This advantage is achieved by virtue of the fact that the drive means is selectively positionable between an operative state and an inoperative state whereby the length of the log splitter is substantially similar to the length of the support element.

These and other advantages of the invention will become readily apparent to those skilled in the art by the following description of some preferred non-limiting embodiments thereof, which are given by way of example only, with reference to the accompanying drawings, in which:

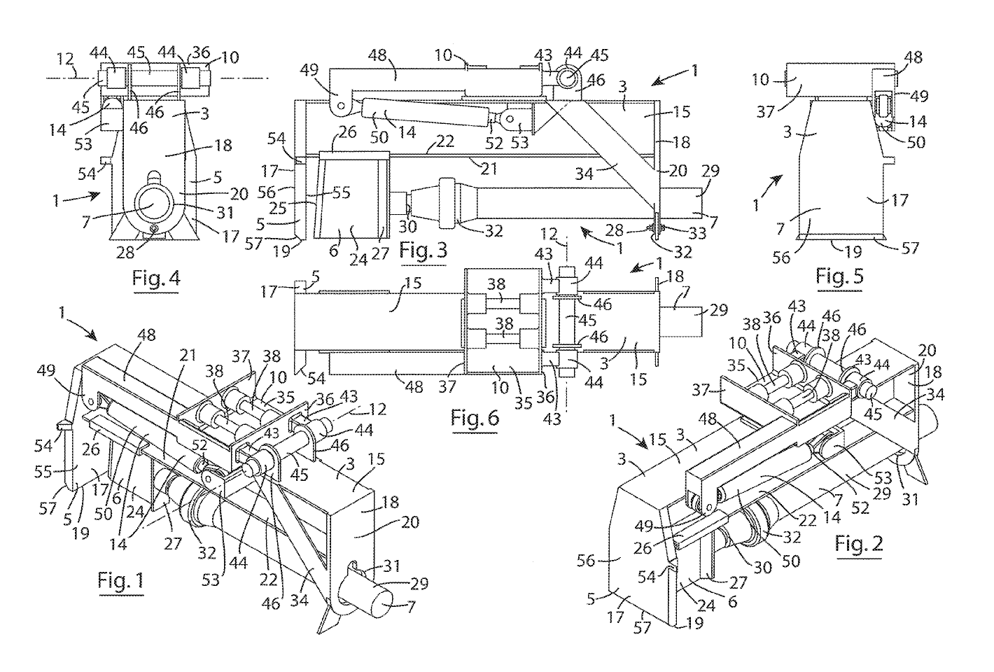

FIG. 1 is a perspective view of a log splitter according to the invention with a portion of the log splitter in an inoperative state,

FIG. 2 is another perspective view of the log splitter of FIG. 1 with the portion of the log splitter in the same state as that of FIG. 1,

FIG. 3 is a side elevational view of the log splitter of FIG. 1 with the portion of the log splitter in the same state as that of FIG. 1,

FIG. 4 is an end elevational view of the log splitter of FIG. 1 with the portion of the log splitter in the same state as that of FIG. 1,

FIG. 5 is another end elevational view of the log splitter of FIG. 1 from the end opposite to that of FIG. 4 with the portion of the log splitter in the same state as that of FIG. 1,

FIG. 6 is a top plan view of the log splitter of FIG. 1 with the portion of the log splitter in the same state as that of FIG. 1,

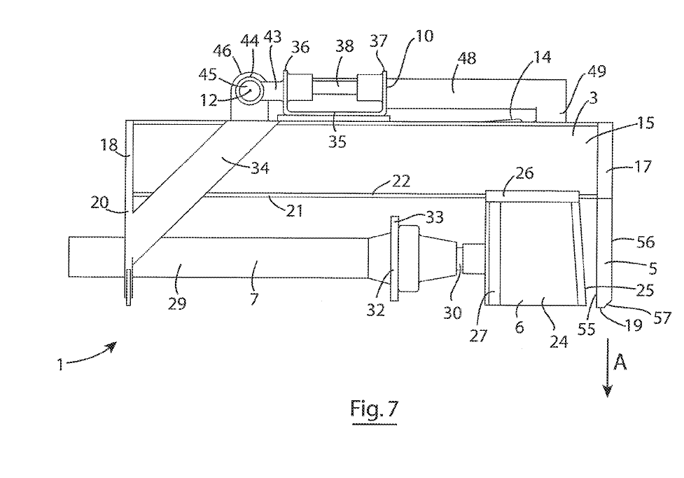

FIG. 7 is a side elevational view of the log splitter of FIG. 1 from the side opposite to that of FIG. 3 with the portion of the log splitter in the same state as that of FIG. 1,

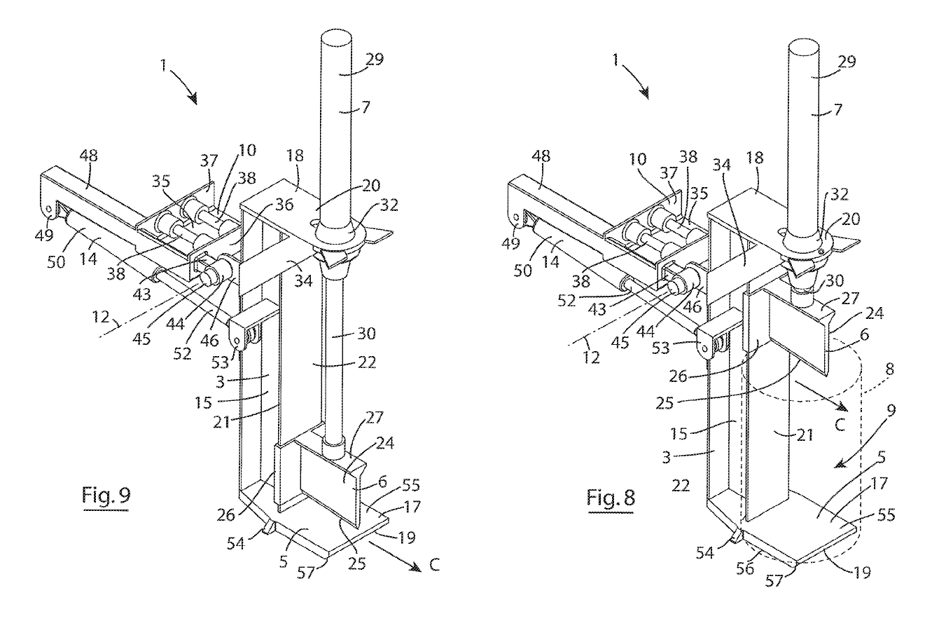

FIG. 8 is a perspective view of the log splitter of FIG. 1 in a different state to that of FIG. 1, with the portion of the log splitter in an operative state, and another portion of the log splitter in a receiving state,

FIG. 9 is another perspective view of the log splitter of FIG. 1 in the state of FIG. 8 and with a portion of the log splitter in a splitting state,

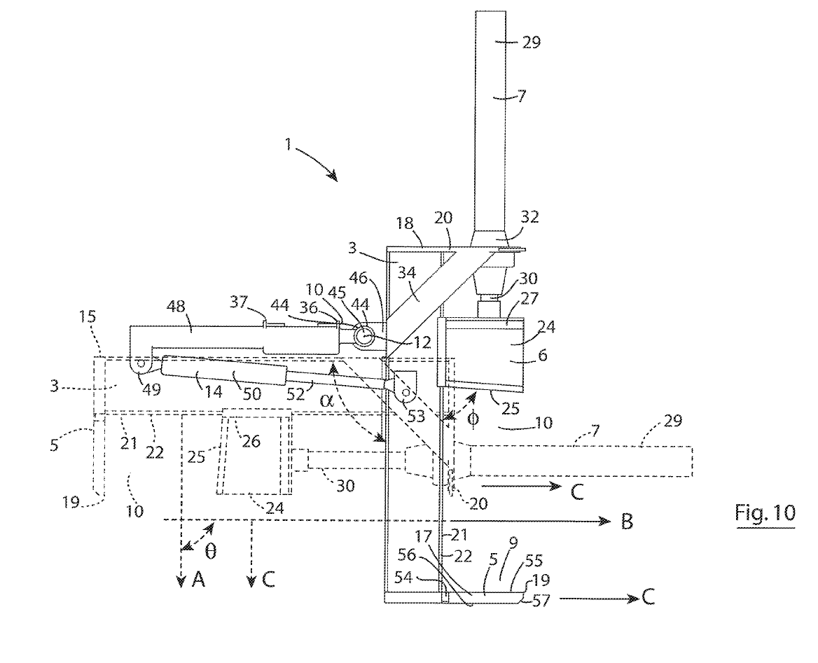

FIG. 10 is a side elevational view of the log splitter of FIG. 1 illustrating the log splitter in two states,

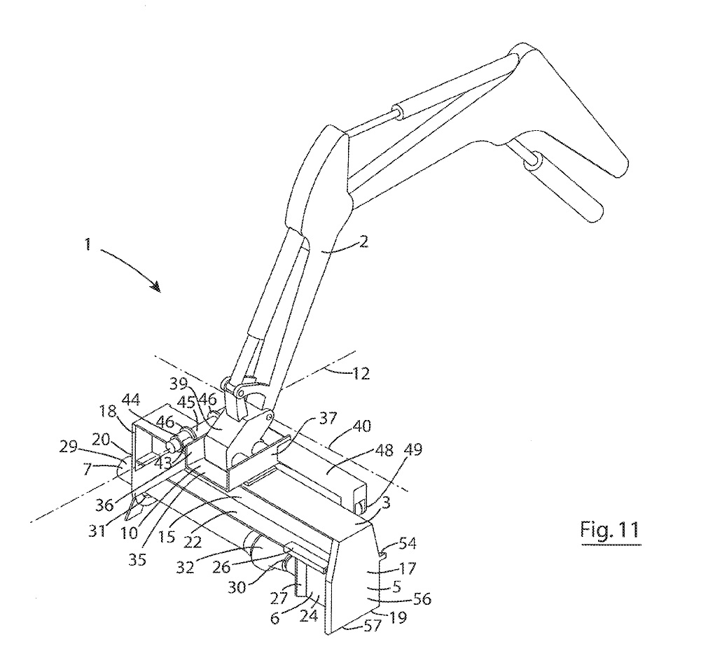

FIG. 11 is a perspective view of the log splitter of FIG. 1 illustrated mounted on a dipper arm of a prime mover,

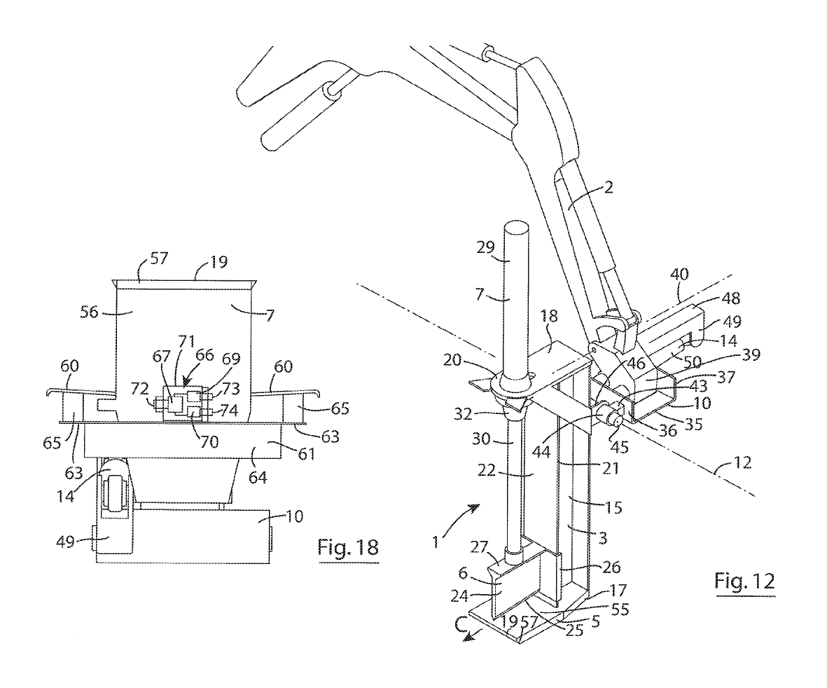

FIG. 12 is another perspective view of the log splitter of FIG. 1 also illustrated mounted on the dipper arm of a prime mover,

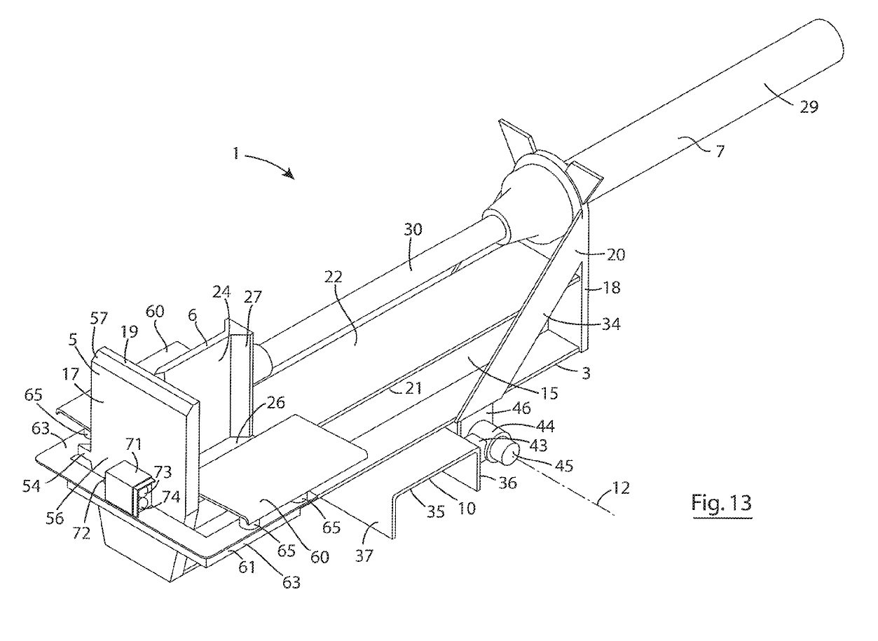

FIG. 13 is a perspective view of the log splitter of FIG. 1 differently configured to the configuration of FIG. 1,

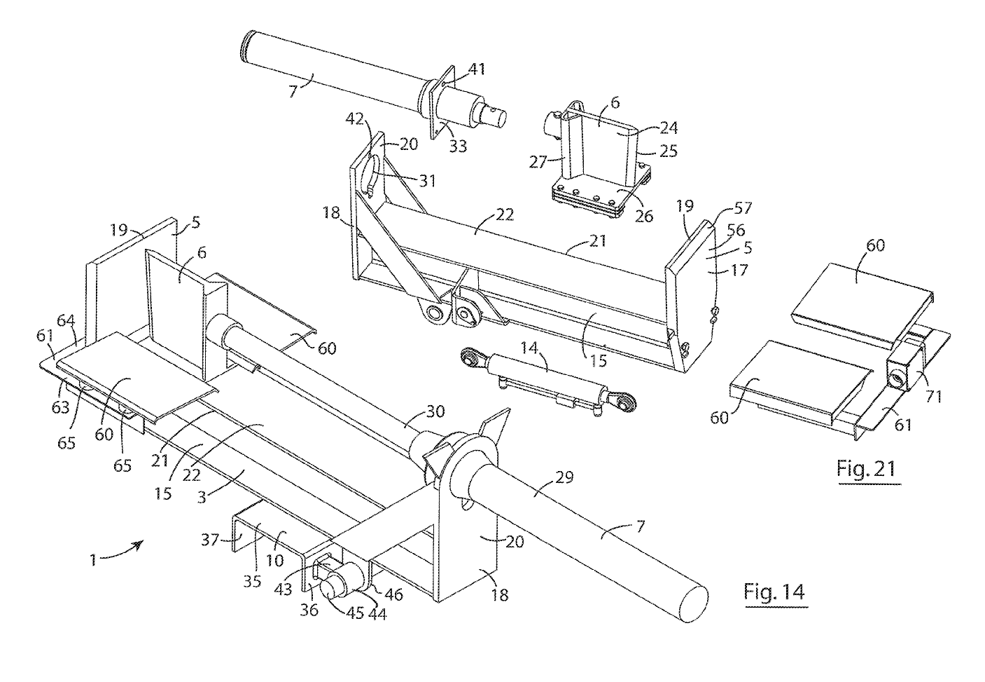

FIG. 14 is another perspective view of the log splitter of FIG. 1 configured as in FIG. 13,

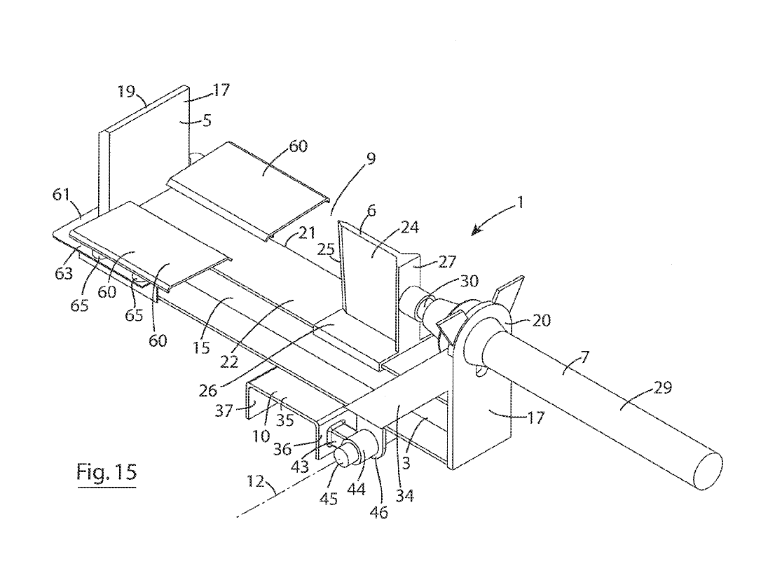

FIG. 15 is a further perspective view of the log splitter of FIG. 1 configured as in FIG. 13,

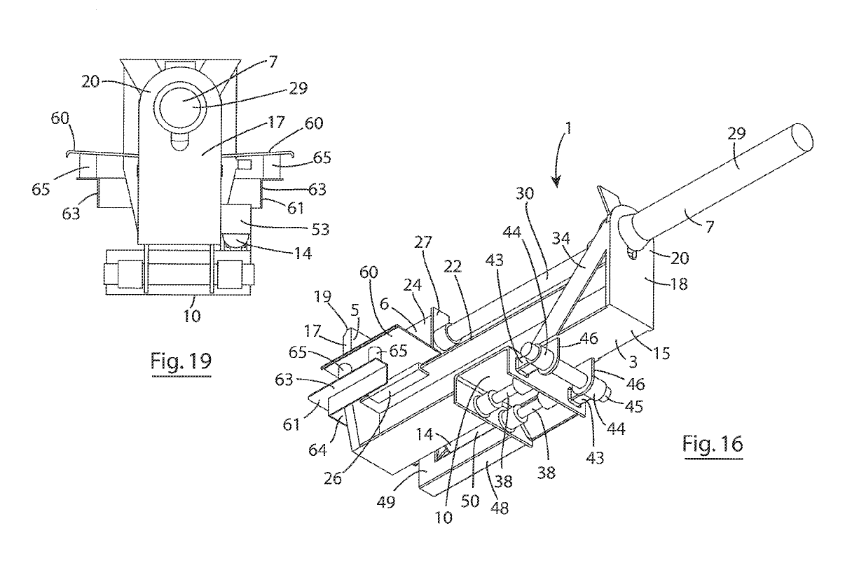

FIG. 16 is an underneath perspective view of the log splitter of FIG. 1 configured as in FIG. 13,

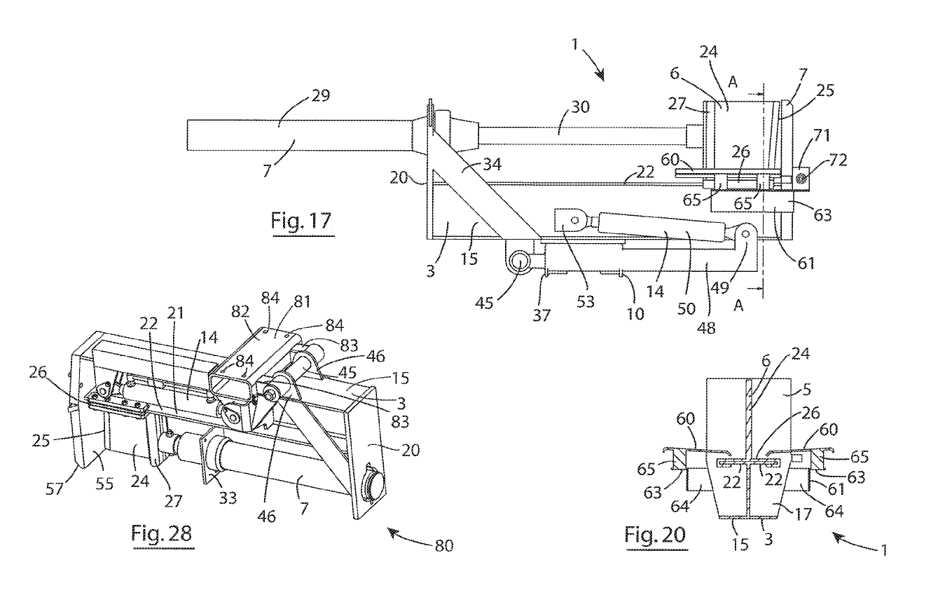

FIG. 17 is a side elevational view of the log splitter of FIG. 1 configured as in FIG. 13,

FIG. 18 is an end elevational view of the log splitter of FIG. 1 configured as in FIG. 13,

FIG. 19 is an end elevational view of the log splitter of FIG. 1 from the other end to that of FIG. 18 configured as in FIG. 13,

FIG. 20 is a transverse cross-sectional end elevational view of the log splitter of FIG. 1 configured as in FIG. 13 on the line XX-XX of FIG. 17.

FIG. 21 is an exploded perspective view of some of the parts of the log splitter of FIG. 1,

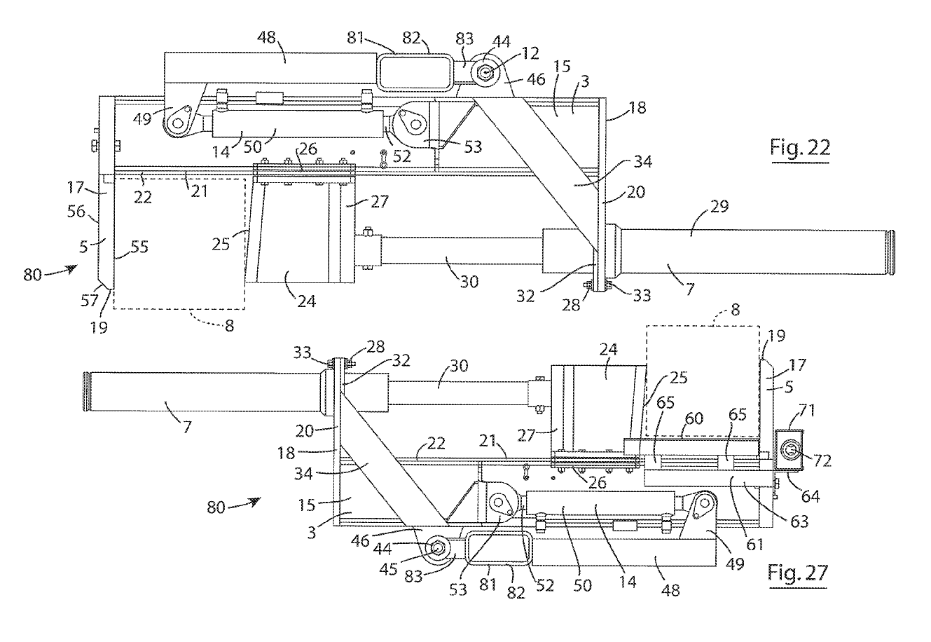

FIG. 22 is a side elevational view of a log splitter according to another embodiment of the invention in a configuration similar to the configuration illustrated in FIGS. 1 to 12 of the log splitter of FIGS. 1 to 21.

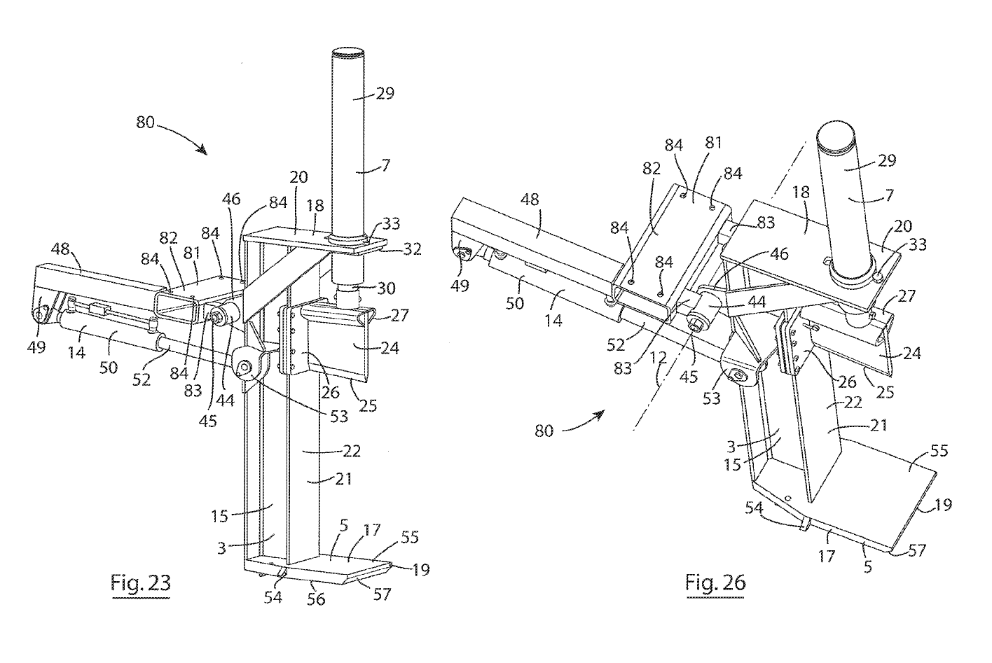

FIG. 23 is a perspective view of the log splitter of FIG. 22 in the configuration of FIG. 22, but in a different state to that of FIG. 22,

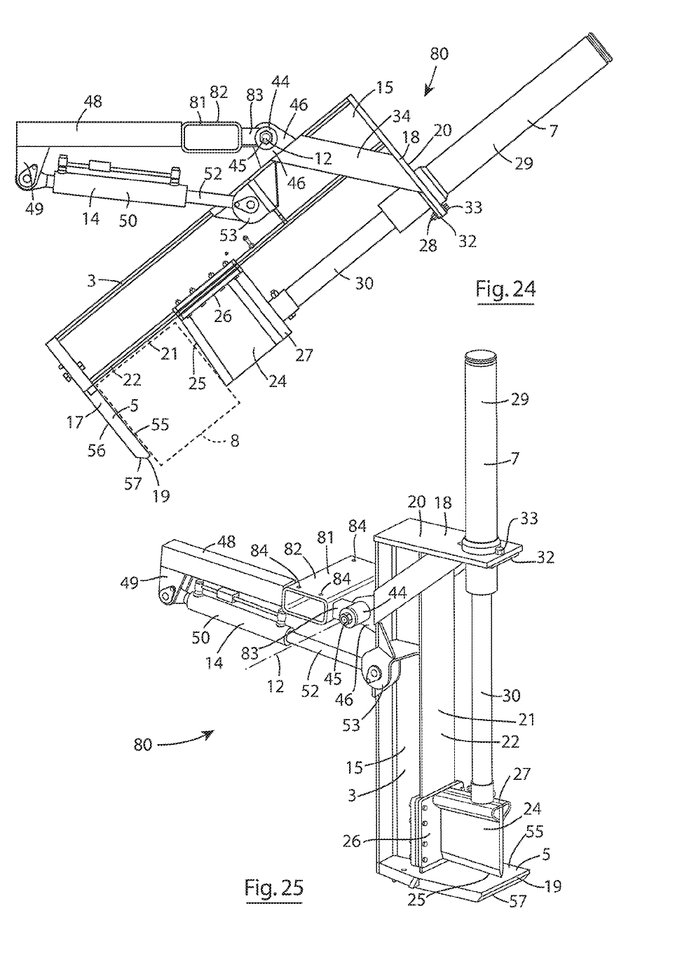

FIG. 24 is another perspective view of the log splitter of FIG. 22 in the orientation of FIG. 22, but in a state intermediate to that of FIGS. 22 and 23,

FIG. 25 is a further perspective view of the log splitter of FIG. 22 in the configuration of FIG. 22, but in the state of FIG. 23,

FIG. 26 is a further perspective view of the log splitter of FIG. 22 in the configuration of FIG. 22 and in the state of FIG. 23,

FIG. 27 is a side elevational view of the log splitter of FIG. 22 in the configuration of FIGS. 13 to 20 of the log splitter of FIGS. 1 to 21, and

FIG. 28 is another perspective view of the log splitter of FIG. 22 in the configuration of FIG. 22, and with a portion of the log splitter in the inoperative state.

Referring to the drawings and initially to FIGS. 1 to 21 thereof, there is illustrated a log splitter according to the invention, indicated generally by the reference numeral 1, for mounting on a working arm, namely, a dipper arm 2 of a prime mover, such as an earth moving machine (not shown) for splitting logs. The combination of the dipper arm 2 and the log splitter 1 is also according to the invention, as is the prime mover (not shown) with the dipper arm 2 and the log splitter 1 attached thereto. The log splitter 1 is illustrated in one configuration in FIGS. 1 to 12, and in another configuration in FIGS. 13 to 20. In the configuration of FIGS. 1 to 12, the log splitter is configured mounted on the dipper arm 2 of an earth working machine, wherein the log splitter 1 is operated by an operator from the cab of the earth working machine. In the configuration of FIGS. 13 to 20, the log splitter 1, while still mounted on the dipper arm 2 of the earth working machine, is manually operable for splitting relatively small logs, which are manually fed to the log splitter 1, as will be described below with reference to FIGS. 13 to 20. Initially, the log splitter 1 will be described in the configuration of FIGS. 1 to 20.

Turning now to FIGS. 1 to 12, the log splitter 1 comprises an elongated support element 3 having an anvil 5 extending from one end thereof and a splitting element 6 slideably mounted on the support element 3 and urgeable by a drive means, namely, a primary hydraulic ram 7 between a receiving state illustrated in FIGS. 8 and 10 and defining with the anvil 5 an open mouth 9 for receiving a log 8 therein, to a splitting state illustrated in FIGS. 9 and 12 with the splitting element 6 co-operating with the anvil 5 for splitting the log.

A mounting means, namely, an inverted U-shaped mounting element 10 for coupling the log splitter 1 to the dipper arm 2 is pivotally coupled to the support element 3 with the support element 3 pivotal relative to the mounting element 10 about a main pivot axis 12. An urging means, namely, a secondary hydraulic ram 14 operably coupled between the mounting element 10 and the support element 3 pivots the support element 3 through an angle a relative to the mounting element 10 about the main pivot axis 12 from a first state, illustrated in broken lines in FIG. 10, with the open mouth 9 defined between the splitting element 6 and the anvil 5 facing in a first direction relative to the mounting element 10, through a plurality of intermediate states, to a second state, illustrated in full lines in FIG. 10, with the open mouth 9 defined between the splitting element 6 and the anvil 5 extending in a second direction relative to the mounting element 10 with the second direction extending at an angle θ, relative to the first direction. In FIG. 10 the open mouth 9 defined between the splitting element 6 and the anvil 5 is illustrated in broken lines facing in the first direction, which is illustrated by the arrow A, and in the open mouth 9 is illustrated in full lines in FIG. 10 facing in the second direction, which is illustrated by the arrow B. In this embodiment of the invention the angles α and θ are approximately 95°. However, the angles α and θ may be any angle greater than zero, and ideally, will be in the order of 90°.

Turning now in more detail to the construction of the log splitter 1, the support element 3 comprises a longitudinally extending main central member 15 provided by an I-section beam. A pair of spaced apart end plates 17 and 18 of steel plate material extend substantially perpendicularly from the main central member 15 at respective opposite ends thereof in a leading direction, namely, the direction of the arrow C, which is the direction that the log splitter 1 is urged towards a log to be split. The end plate 17 forms the anvil 5. The anvil 5 formed by the end plate 17 extends from the support element 3 in the leading direction, and terminates in a distal leading edge 19 spaced apart from the support element 3. The end plate 18 forms a mounting bracket 20 to which the primary hydraulic ram 7 is coupled as will be described below.

A guide means for guiding the splitting element 6 longitudinally along and parallel to the support element 3 between the receiving state and the splitting state comprises an elongated guide member 21, which extends longitudinally along the support element 3, and in this embodiment of the invention comprises one of the webs 22 of the I-beam of the main central member 15.

The splitting element 6 comprises a splitter blade 24 of hardened steel plate material welded to and extending from a guide bracket 26. The guide bracket 26 is slideably engageable with the guide member 21 of the support element 3 for guiding the splitting element 6 along the support element 3 between the receiving state and the splitting state. One edge of the splitter blade 24 extending from the guide bracket 26 forms a sharpened cutting edge 25 which faces towards and co-operates with the anvil 5 for splitting a log when the splitting element 6 is in the splitting state. The splitter blade 24 of the splitting element 6 extends substantially perpendicularly from the support element 3 in the leading direction. The cutting edge 25 of the splitter blade 24 is angled at an acute angle φ of approximately 75° relative to the support element 3 towards the anvil 5, so that the splitter blade 24 progressively engages a log as the splitting element 6 is being urged from the receiving state to the splitting state, and also retains the log between the splitting element 6 and the anvil 5. A connecting bracket 27 extending from the guide bracket 26 is welded to the splitter blade 24 along an edge of the splitter blade 24 opposite to the cutting edge 25 for connecting the splitting element 6 to the primary hydraulic ram 7.

A housing 29 of the primary hydraulic ram 7 is releasably coupleable to the mounting bracket 20, and a piston rod 30 of the primary hydraulic ram 7 is coupled to the connecting bracket 27 of the splitting element 6. An opening 31 in the mounting bracket 20 accommodates the housing 29 of the primary hydraulic ram 7 therethrough. In this embodiment of the invention the primary hydraulic ram 7 is selectively coupleable to the mounting bracket 20 in an operative state illustrated in FIGS. 8 to 10 and 12, and is releasable from the mounting bracket 20 to be urged through the opening 31 into an inoperative state illustrated in FIGS. 1 to 7 and 11.

A releasable securing means for coupling the primary hydraulic ram 7 to the mounting bracket 20 comprises a coupling flange 32 mounted on and extending around the housing 29 of the primary hydraulic ram 7 and a screw 33 and a nut 28. A bore 41 extending through the coupling flange 32 is alignable with a bore 42 extending through the mounting bracket 20, and the screw 33 extending through the bores 41 and 42 with the nut 28 secures the first hydraulic ram 7 to the mounting plate 20 in the operative state. The bores 41 and 42 of the coupling flange 32 and the mounting bracket 20 are illustrated in FIG. 21. On disengagement of the screw 33 from the coupling flange 32 and the mounting bracket 20, the primary hydraulic ram 7 is released from the mounting bracket 20, and can be passed through the opening 31 in the mounting bracket 20. Thus, with the splitting element 6 in the splitting state adjacent the anvil 5, and with the piston rod 30 retracted into the housing 29 of the primary hydraulic ram 7, the primary hydraulic ram 7 is located in the inoperative state, so that the overall size, namely, the overall length of the log splitter 1 in the longitudinal direction of the support element 3 is reduced by the length of the housing 29 of the primary hydraulic ram 7. When it is desired to operate the log splitter 1, the housing 29 of the primary ram 7 is urged through the opening 31 in the mounting bracket 20 into the operative state, and is secured therein with the coupling flange 32 secured to the mounting bracket 20 by the screw 33 and the nut 28. Bracing struts 34 extend between the main central member 15 of the support element 3 and the mounting bracket 20 for bracing the mounting bracket 20 to the main central member 15.

Turning now to the mounting element 10, the mounting element 10 is adapted for coupling the log splitter 1 to a coupling element, namely, a quick attachment coupler 39, which is pivotally coupled to the dipper arm 2 about a coupler pivot axis 40. The mounting element 10 comprises a base plate 35 of steel plate material and a pair of spaced apart side plates 36 and 37 also of steel plate material extending from the base plate 35 and welded thereto. A pair of spaced apart coupling members 38 extend between the side plates 36 and 37 for engaging couplers (not shown) of the quick attachment coupler 39. Such quick attachment couplers as the quick attachment coupler 39 of a dipper arm 2 and their couplers for releasably engaging the coupling members 38 of the mounting element 10 will be well known to those skilled in the art.

A main pivot shaft 45 which defines the main pivot axis 12 is carried on a pair of coupling brackets 46 extending from the main central member 15 of the support element 3. A pair of spaced apart mounting members 43 extending from the side plate 36 of the mounting element 10 carry mounting bearings 44 which pivotally engage the main pivot shaft 45 for pivotally coupling the support element 3 to the mounting element 10, so that the support element 3 is pivotal between the first and second states relative to the mounting bracket 10 about the main pivot axis 12.

A carrier bracket 48 extending from the side plate 37 of the mounting element 10 terminates in an anchor bracket 49 to which a housing 50 of the secondary hydraulic ram 14 is pivotally coupled. A piston rod 52 of the secondary hydraulic ram 14 extending from the housing 50 is pivotally coupled to a pivot bracket 53 welded to the main central member 15 of the support element 3. The secondary hydraulic ram 14 acts between the anchor bracket 49 and the pivot bracket 53 for pivoting the support element 3 through the intermediate states between the first and second states about the main pivot axis 12 relative to the mounting element 10.

The coupling brackets 46 mounted on the support element 3 carry the main pivot shaft 45 with the main pivot shaft 45, and in turn the main pivot axis 12 extending transversely relative to the support element 3, and also transversely relative to the leading direction, namely, the direction of the arrow C, from which the anvil 5 extends from the support element 3, see FIGS. 8, 9 and 12. Additionally, the coupling brackets 46 carry the main pivot shaft 45 so that the main pivot shaft 45 and in turn the main pivot axis 12 extend in a direction which is substantially perpendicular to the leading direction, namely, the direction of the arrow C, from which the anvil 5 extends from the support element 3, see FIGS. 8, 9 and 12. Furthermore, the mounting element 10 is configured relative to the main pivot shaft 45 so that when the log splitter 1 is coupled to the quick attachment coupler 39, the coupler pivot axis 40 about which the quick attachment coupler 39 is pivotal relative to the dipper arm 2 extends in a direction substantially perpendicular to the main pivot axis 12, and additionally, the coupler pivot axis 40 extends in a direction substantially parallel to the leading direction, namely, the direction of the arrow C, from which the anvil 5 extends from the support element 3, see FIG. 12.

Accordingly, by virtue of the configuration of the main pivot axis 12 relative to the support element 3 and the leading direction, namely, the direction of the arrow C, from which the anvil 5 extends from the support element 3, the support element 3 is pivotal about the main pivot axis 12 from the first state illustrated in broken lines in FIG. 10 with the open mouth 9 defined between the splitter element 6 and the anvil 5 extending in the first direction, namely, in the direction of the arrow A, and the second state illustrated in full lines in FIG. 10 with the open mouth 9 defined between the splitter element 6 and the anvil 5 extending in the second direction, namely, in the direction of the arrow B, whereby the second direction extends at the angle θ to the first direction, which in this embodiment of the invention is approximately 95°. This provides the log splitter 1 with its many advantages, in particular, it allows the log splitter to be operated in the first state with the support element 3 extending substantially horizontally, and the anvil 5 and the splitter element 6 extending in a generally downwardly direction with the open mouth defined between the splitter element 6 and the anvil 5 facing downwardly in the first direction, namely, in the direction of the arrow A, see FIG. 10, for engaging a log lying, for example, horizontally on the ground, and with the grain of the log extending substantially horizontally. Alternatively, the log may be a disc type log resting on the ground with the grain extending vertically, and in which case, the log splitter with the support element 3 in the first state and the open mouth facing downwardly in the first direction would engage the log, and the splitting element 6 would be urged by the primary hydraulic ram 7 transversely across the log for splitting the log transversely across the grain.

By pivoting the support element 3 about the main pivot axis 12 relative to the mounting element 10 through the angle α from the first state to the second state, the open mouth 9 defined between the splitting element 6 and the anvil 5 now faces in the second direction, namely, in the direction of the arrow B, see FIG. 10, in other words in a substantially horizontal direction. With the support element 3 in the second state, a log which is standing substantially vertically on the ground or elsewhere with the grain extending also substantially vertically is engageable in the open mouth 9 between the anvil 5 and splitting element 6, with the log and the grain thereof extending substantially parallel to the support element 3.

By pivoting the support element 3 about the main pivot axis 12 relative to the mounting element 10 from the first or second states into any of the intermediate states between the first and second states, the angle of the support element 3 relative to the mounting element 10 may be set at any desired angle, so that the support element extends substantially parallel to a log to be split which is at an angle inclined to the vertical, for example, a log supported inclined on a pile of logs or the like. When the support element 3 of the log splitter 1 is aligned parallel with the inclined log, the log splitter 1 approaches the log with the open mouth 9 defined between the splitting element 6 and the anvil 5 facing in the leading direction, namely, in the direction of the arrow C, which is substantially perpendicularly to the log. Needless to say, the support element 3 may be urged by the secondary hydraulic ram 14 about the main pivot axis 12 relative to the mounting plate 10 into any intermediate state at any angle a relative to the mounting element 10, so that the support element 3 is aligned substantially parallel with an inclined log with the grain extending parallel to the support element 3, or transversely of the support element 3 as the case may be. This, thus, allows a log to be picked up from the ground or from a pile of logs or elsewhere irrespective of the orientation of the log and to be split without the need for any manual intervention to manoeuvre the log into alignment with the log splitter 1, since the log splitter 1 can be aligned with the log.

Returning now to the anvil 5, the end plate 17 which forms the anvil 5 defines an inner major surface 55 which faces towards the splitting element 6 and an opposite outer major surface 56 which faces away from the splitting element 6. A distal portion 57 of the end plate 17 adjacent the distal leading edge 19 of the anvil 5 tapers towards the distal leading edge 19 to form a lead-in for facilitating urging the distal leading edge 19 of the anvil 5 beneath a log and between the log and the surface on which the log is supported. In order to maximise the efficiency with which the distal leading edge 19 of the anvil 5 engages beneath a log and between the log and the surface on which the log is standing, the tapering distal portion 57 of the anvil 5 is formed by chamfering the outer major surface 56 along the distal leading edge 19 of the anvil 5.

Indeed, it is the configuration of the main pivot axis 12 relative to the mounting element 10 and the support element 3, which allows the log splitter 1 when in the second state or in an intermediate state between the first state and the second state to be manoeuvred by the dipper arm 2 and the quick attachment coupler 39, so that the distal leading edge 19 of the anvil 5 is the lowest part of the log splitter 1, thereby enabling the anvil 5 to be readily engaged beneath a log and between the log and the surface, for example, the ground on which the log is supported. This provides a particularly important advantage of the invention, in that it allows the splitting of logs which are of size and weight greater than that which can be manhandled.

A projection 54 extends sidewardly from one side of the end plate 17 which forms the anvil 5 for engaging a log when the support element 3 is in the second state, see, for example, FIGS. 8 and 9, or in an intermediate state between the first and second states, for in turn urging a log towards the earth working machine. In other words, when the log splitter 1 is coupled to the dipper arm 2 of an earth working machine, and the support element 3 is in the second state, the log splitter 1 effectively extends the reach of the dipper arm 2, and the projection 54 facilitates engagement of a log which is at the outer extremity of the reach of the combination of the dipper arm 2 and the log splitter 1 for nudging the log towards the earth working machine without any human intervention. Once closer to the earth working machine the log can then be engaged in the open mouth 9 defined between the anvil 5 and the splitting element 6 for splitting of the log. The projection 54 tapers towards its distal end.

In use, with the housing 29 of the primary hydraulic ram 7 secured to the mounting bracket 20 in the operative state by the coupling flange 32 and the screw 33 and nut 28, and with the log splitter 1 coupled to the quick attachment coupler 39 of the dipper arm 2 of an earth working machine or any other suitable prime mover, and with the primary and secondary hydraulic rams 7 and 14 coupled to the hydraulic system of the earth working machine, the log splitter 1 is ready for use. When it is desired to split a log lying on the ground with the grain of the log extending horizontally, the log splitter 1 with the support element 3 in the first state and the splitting element 6 in the receiving state is lowered onto the log with the open mouth 9 defined between the splitting element 6 and the anvil 5 facing in the first direction of the arrow A generally downwardly, so that the log is located between the anvil 5 and the splitting element 6. When the log is located between the splitting element 6 and the anvil 5, the primary hydraulic ram 7 is operated for urging the splitting element 6 from the receiving state to the splitting state for splitting the log along the grain thereof.

When it is desired to split a log resting on the ground, or indeed, resting on another log with the grain of the log extending in a generally vertical direction, the support element 3 is urged by the secondary hydraulic ram 14 from the first state to the second state, and the dipper arm 2 is manoeuvred so that the distal leading edge 19 of the anvil 5 is the lowest part of the log splitter 1. With the splitting element 6 in the receiving state, the distal leading edge 19 of the anvil 5, and in turn the anvil 5 is urged by the dipper arm 2 beneath the log to be split and between the log to be split and the surface on which the log is supported, so that the log is located in the open mouth 9 between the anvil 5 and the splitting element 6. The primary hydraulic ram 7 is then operated for urging the splitting element 6 from the receiving state to the splitting state for splitting the log.

In the event of a log lying on the ground or on a pile of logs or elsewhere, and the log or the grain of the log is inclined to the vertical, the secondary hydraulic ram 14 is operated to pivot the support element 3 relative to the mounting element 10 into an appropriate one of the intermediate states between the first state and the second state, so that the support element 3 extends substantially parallel to the direction along which the log is to be split, and the open mouth 9 defined between the splitting element 6 and the anvil 5 is facing in the leading direction towards the log in a direction substantially perpendicular to the direction along which the log is to be split. The log splitter 1 is then urged towards the log for engaging the log between the anvil 5 and the splitting element 6.

When the splitting of the logs has been completed, and it is desired to drive the earth working machine on a public road or highway, the support element 3 is urged by the secondary hydraulic ram 14 into the first state, the primary hydraulic ram 7 is operated to urge the splitting element 6 into the splitting state adjacent the anvil 5, and the housing 29 of the primary hydraulic ram 7 is decoupled from the mounting bracket 20 by releasing the coupling flange 32 from the mounting bracket 20. The primary hydraulic ram 7 is then operated for retracting the piston rod 30 into the housing 29, for in turn urging the housing 29 through the opening 31 in the mounting bracket 20, so that the housing 29 of the primary hydraulic ram 7 is in the inoperative state located substantially within and between the end plates 17 and 18, with the overall length of the log splitter 1 minimised. Additionally, when the log splitter 1 is to be removed from the dipper arm 2 of the earth working machine and stored, prior to removal of the log splitter 1 from the dipper arm 2, the primary hydraulic ram 7 is decoupled from the mounting bracket 20, and the primary hydraulic ram 7 is operated as already described in order to locate the housing 29 of the primary hydraulic ram 7 substantially within the support element 3 in the inoperative state, in order to minimise the overall length of the log splitter 1 for storing thereof.

Referring now to FIGS. 13 to 20, the log splitter 1 is illustrated in the second configuration wherein the log splitter 1 is adapted to be operable manually while still coupled to the quick attachment coupler 39 of the dipper arm 2 and supplied by the hydraulic system of the prime mover. However, in the second configuration the quick attachment coupler 39 and the dipper arm 2 are operated, so that the quick attachment coupler 39 is located beneath the log splitter 1, and is essentially resting on the ground, the log splitter 1 is operated with the support element 3 in the first state, and oriented by the orientation of the quick attachment coupler 39 as illustrated in FIGS. 13 to 20 with the open mouth 9 defined between the splitting element 6 and the anvil 5 facing in a generally upwardly direction for receiving a log to be split in the open mouth 9.

In the second configuration a pair of support members, namely, support plates 60 which are carried on a framework 61 are releasably mounted on the support element 3 and are located on respective opposite sides of the support element 3 adjacent the anvil 5 for supporting the log to be split in the open mouth 9 defined between the splitting element 6 and the anvil 5. The framework 61 is of U-shaped construction having a pair of spaced apart side members 63 joined by a cross-member 64 which is releasably secured to the end member 17 which forms the anvil 5. A pair of resilient mounting members 65 spaced apart on the respective side members 63 resiliently support the support plates 60 on the framework 61, in order to allow the support plates 60 to resiliently flex relative to the framework 61 in response to an impact with a log or a portion of a log as the log is being split, to avoid the support plates 60 being detached from the framework 61. Additionally, the resilient mounting members 65 mount the support plates 60 spaced apart from the guide member 21 in order to accommodate the guide bracket 26 of the splitting element 6 between the guide member 21 and the support plates 60 as the splitting element 6 is urged between the receiving state and the splitting state.

In the second configuration, for safety, the primary hydraulic ram 7 is manually operated between the receiving and splitting states through a manually operable control means comprising a safety interlock circuit 66. The safety interlock circuit 66 comprises three switches, namely, an isolation switch 67 for selectively isolating the primary drive ram 7 from the hydraulic power supply of the prime mover, a pair of direction switches 69 and 70. The direction switches 69 and 70 determine the direction in which pressurised hydraulic fluid from the isolating switch 68 is supplied to the primary hydraulic ram 7, for determining the direction in which the splitting element 6 is urged by the primary hydraulic ram 7. The switches 67, 69 and 70 are located in a housing 71 mounted on the framework 61 adjacent the anvil 5. Push button switches 72, 73 and 74 are provided for selectively operating the switches 67, 69 and 70. The housing 71 and the switches 67, 69 and 70 are configured on the framework 61 so that in order to operate the primary hydraulic ram 7, two hands of the operator are required, one hand to operate the isolating switch 67 by the push button 72, and the other hand to operate the appropriate one of the switches 69 and 70 by the corresponding one of the push buttons 73 and 74, depending on whether the splitting element is to be moved from the receiving state to the splitting state or vice versa.

In use, with the log splitter 1 coupled to the quick attachment coupler 39, and with the dipper arm 2 and the quick attachment coupler 39 operated with the quick attachment coupler 39 resting on the ground and the log splitter 1 oriented with the open mouth 9 defined between the splitting element 6 and the anvil 5 facing in a generally upwardly direction, the framework 61 comprising the support plates 60 is coupled to the support element 3 with the support plates 60 located on and extending on respective opposite sides of the support element 3. The safety interlock circuit 66 is coupled between the primary hydraulic ram 7 and the hydraulic power supply 68 of the earth working machine.

With the splitting element 6 in the receiving state, a log to be split is placed in the open mouth 9 between the splitting element 6 and the anvil 5 resting on the support plate 60. The push button 72 of the isolating switch 67 is operated by one hand of the operator for applying pressurised hydraulic fluid to the primary hydraulic ram 7, and the push button 73 of the switch 69 is operated by the other hand of the operator for in turn supplying pressurised hydraulic fluid to the primary hydraulic ram 7 for urging the splitting element 6 from the receiving state to the splitting state for splitting the log. The splitting element 6 is returned to the receiving state by the primary hydraulic ram 7 by operating the push button 74 of the switch 70 for powering the primary hydraulic ram 7 for in turn returning the splitting element 6 to the receiving state.

Alternatively, the interlock circuit 66 may be configured so that on the splitting element 6 being urged into the splitting state for splitting the log, the direction of the primary hydraulic ram 7 would be automatically reversed for returning the splitting element 6 to the receiving state.

Additionally, in this embodiment of the invention although not illustrated, a micro-switch is located on the support element 3 which is engageable with the guide bracket 26 when the splitting element 6 is returning from the splitting state and has reached a position with the cutting edge 25 of the splitter blade 24 substantially adjacent the free ends 75 of the support plates 60. This, thus, minimises the travel of the splitting element 6 between the receiving and splitting states, and thereby reduces the cycle time of the splitting element 6 travelling from the receiving state to the splitting state and returning to the receiving state.

When it is desired to use the log splitter 1 in the first configuration illustrated in FIGS. 1 to 12, the framework 61 with the support plates 60 is removed from the support element 3, the safety interlock circuit 66 is disconnected and the primary hydraulic ram 7 is coupled directly into the hydraulic system of the earth working machine.

Referring now to FIGS. 22 to 27, there is illustrated a log splitter according to another embodiment of the invention, indicated generally by the reference numeral 80. The log splitter 80 is substantially similar to the log splitter 1 and similar components are identified by the same reference numerals. The only difference between the log splitter 80 and the log splitter 1 is in the mounting means for mounting the log splitter 80 to the quick attachment coupler 39. In this embodiment of the invention the mounting means comprises a mounting element 81 of rectangular box section which forms a planar mounting plate 82. The mounting element 81 is pivotally coupled to the main pivot shaft 45 by pivot coupling brackets 83 extending from the mounting element 81, so that the support element 3 is pivotal relative to the mounting element 81 about the main pivot axis 12 in a similar manner as the support element 3 is pivotal about the main pivot axis 12 relative to the mounting element 10 of the log splitter 1. The mounting plate 82 of the mounting element 81 is provided with a plurality of fixing openings 84 for facilitating securing of a coupling bracket (not shown), which would be similar to the U-shaped mounting element 10 of the log splitter 1 for securing the mounting element 81 to a quick attachment coupler substantially similar to the quick attachment coupler 39 described with reference to the log splitter 1.

It has been found that different quick attachment couplers are provided with different types, shapes and sizes of couplers for releasably coupling an attachment to such quick attachment couplers. Indeed, it has also been found that the spacing between the couplers of such quick attachment couplers varies from one type of quick attachment coupler to another. It is envisaged that when supplying the log splitter 80, the log splitter 80 would be supplied with an appropriate coupling bracket secured by screws through the fixing openings 84 to the mounting plate 82 of the mounting element 81 for attaching the log splitter 80 to the quick attachment coupler of the earth working machine to which it is to be coupled. The coupling bracket would be provided with coupling members of the type of the coupling member 38 of the mounting element 10, but sized, shaped and spaced apart to suit the quick attachment coupler, to which the log splitter is to be attached.

Otherwise, the log splitter 80 is similar to the log splitter 1 and its operation is likewise similar.

It is envisaged that in the case of both log splitters 1 and 80, the distance of travel of the splitting element 6 from the anvil 5 when the splitting element 6 is being urged from the splitting state to the receiving state may be selectable so that when it is desired to split relatively short logs or to split logs across the diameter of the log, the width of the open mouth 9 defined between the splitting element 6 and the anvil 5 when the splitting element 6 is in the receiving state, would be less than the width of the open mouth 9 when the log splitters 1 and 80 are being used to split relatively long logs. This would reduce the cycle time of the primary hydraulic ram as it cycles for urging the splitting element 6 from the receiving state to the splitting state and back to the receiving state. It is envisaged that a plurality of micro-switches or poppit valves longitudinally spaced apart along the support element 3 would be provided which would be engageable with the guide bracket 26 of the splitting element 6 to terminate the stroke of the primary hydraulic ram 7, when the guide bracket 26 reached a selected one of the micro-switches or poppit valves, as the splitting element 6 was being urged from the splitting state to the receiving state. Thereby, by selecting an appropriate one of the micro-switches or poppit valves, the stroke of the primary hydraulic ram 7 could be selected. The micro-switches or poppit valves would be connected to a control circuit which controls the operation of the primary hydraulic ram, so that on a selected one of the micro-switches or poppit valves being engaged by the guide bracket 26 of the splitting element 6, the supply of hydraulic fluid to the primary hydraulic ram 7 would be tripped in order to stop further movement of the splitting element 6 from the splitting state to the receiving state.

While the support elements of the log splitters 1 and 80 have been described as being of a particular construction, any other suitable construction of support element may be used.

It will also be appreciated that while in the embodiment of the invention described the splitting element is the moveable element of the anvil and the splitting element, in certain cases, the anvil may be the moveable element, while the splitting element would be the stationary element. However, in cases where the anvil is the moveable element and the splitting element is the stationary element, it is envisaged that the splitting element would be located in place of the anvil at one end of the support element, and the anvil 5 would then be moveable towards the splitting element from a receiving position to a splitting position.

While the log splitters have been described as being coupled to a quick attachment coupler of a dipper arm, it will be appreciated that the log splitters may be adapted to be coupled by any suitable coupling element of a dipper arm, or any other working arm of a prime mover, and in certain cases may be attached directly to the dipper arm.

While in the log splitter 1 the mounting means has been described as comprising an inverted U-shaped mounting member, any other suitable mounting element or mounting means for mounting the log splitter to a quick attachment coupler or any other coupler to a dipper arm or to any other working arm of an earth working machine may be provided.

While it is desirable that the primary hydraulic ram should be releasably coupleable to the mounting bracket 20 so that the primary hydraulic ram with the piston thereof retracted and the splitting element 6 in the splitting state is operable in the inoperative state for reducing the overall length of the log splitter, this is not essential. The primary hydraulic ram could be non-releasably coupled to the mounting plate 20. However, the advantage of having the primary hydraulic ram releasably coupled to the mounting plate so that the primary hydraulic ram is operable in the inoperative state to reduce the overall length of the log splitter, an earth working machine with the log splitter coupled to the dipper arm in the state illustrated in FIG. 11 can readily easily be driven along a public road or highway.

It is also envisaged that the log splitters may be operable in the second configuration illustrated in FIGS. 13 to 20 without being coupled to the dipper arm or other working arm of an earth working machine or other prime mover. In which case, the log splitters would be supported on the ground by the mounting element, and the secondary hydraulic ram would be operated to retain the support element in the first state relative to the mounting bracket. The primary hydraulic ram could then be coupled to either an hydraulic supply from an earth working machine or other prime mover, or to an independent pressurised hydraulic fluid source.

1-57. (canceled)

58. A log splitter comprising a support element, an anvil supported on the support element, a splitting element supported on the support element, one of the splitting element and the anvil being moveable from a receiving state with the splitting element and the anvil spaced apart from each other and defining an open mouth therebetween for receiving a log, towards the other one of the splitting element and the anvil to a splitting state with the splitting element and the anvil co-operating with each other to split the log, a drive means for urging the moveable one of the splitting element and the anvil between the receiving state and the splitting state, a mounting means configured for mounting the support element to a working arm of a prime mover, the support element being pivotally coupled to the mounting means about a main pivot axis, and being pivotal about the main pivot axis relative to the mounting means between a first state with the open mouth defined between the splitting element and the anvil facing in a first direction, and a second state with the open mouth defined between the splitting element and the anvil facing in a second direction, the second direction extending at an angle greater than zero relative to the first direction, and an urging means for urging the support element relative to the mounting means about the main pivot axis between the first state and the second state.

59. A log splitter as claimed in claim 58 in which the angle at which the second direction extends relative to the first direction is at least 45°, and preferably, the angle at which the second direction extends relative to the first direction is at least 90, and advantageously, the angle at which the second direction extends relative to the first direction is approximately 95°.

60. A log splitter as claimed in claim 58 in which the support element is pivotal about the main pivot axis from the first state to the second state through an angle greater than zero relative to the mounting means, and advantageously, the support element is pivotal about the main pivot axis from the first state to the second state through an angle of at least 45° relative to the mounting means.

61. A log splitter as claimed in claim 58 in which the support element is pivotal about the main pivot axis from the first state to the second state through an angle of at least 90° relative to the mounting means, and preferably, the support element is pivotal about the main pivot axis from the first state to the second state through an angle of approximately 95° relative to the mounting means, and advantageously, the support element is pivotal about the main pivot axis relative to the mounting means through a plurality of intermediate states between the first and second states, and preferably, the anvil extends in a leading direction from the support element and terminates in a distal leading edge spaced apart from the support element, the open mouth defined between the splitting element and the anvil facing generally in the leading direction from the support element, and advantageously, the support element comprises an elongated support element, and preferably, the main pivot axis extends in a direction substantially transversely relative to the support element, and substantially transversely relative to the leading direction from which the anvil extends from the support element.

62. A log splitter as claimed in claim 58 in which the mounting means is adapted for coupling to a coupling element of a working arm of a prime mover, and preferably, the mounting means is adapted for coupling to a coupling element of a working arm of a prime mover, the coupling element of the working arm of the prime mover being pivotally coupled to the working arm about a coupler pivot axis, and the mounting means is configured for coupling to the coupling element with the coupler pivot axis extending in a direction substantially perpendicularly to the main pivot axis, and substantially parallel to the leading direction from which the anvil extends from the support element.

63. A log splitter as claimed in claim 58 in which the mounting means comprises a mounting element configured to carry a coupling member adapted for engagement by a coupling element of a working arm of a prime mover, and preferably, the coupling member is configured for releasable engagement by a quick release mechanism of a coupling element of a working arm of a prime mover, and advantageously, the mounting element comprises a mounting plate.

64. A log splitter as claimed in claim 58 in which the anvil is rigidly mounted on the support element, and advantageously, the splitting element is moveable between the receiving state and the splitting state longitudinally along the support element, and preferably, a guide means is provided for guiding the splitting element between the receiving state and the splitting state, and advantageously, the guide means is mounted on the support element, and preferably, the splitting element is slideably engageable with the guide means.

65. A log splitter as claimed in claim 58 in which the splitting element comprises a splitter blade, and advantageously, the splitter blade extends in a direction substantially parallel to the leading direction from which the anvil extends from the support element, and preferably, the splitter blade extends in a direction substantially perpendicular to the main pivot axis, and advantageously, the splitter blade terminates in a cutting edge, and preferably, the cutting edge of the blade extends in a direction from the support element substantially parallel to the leading direction from which the anvil extends from the support element, and at an acute angle relative to the support element towards the anvil.

66. A log splitter as claimed in claim 58 in which the drive means is operably coupled between the support element and the splitting element, and advantageously, the drive means is selectively and releasably coupleable to the support element in an operative state, and preferably, the drive means when released from the support element is moveable between the operative state and an inoperative state, and advantageously, the drive means comprises a primary hydraulic ram.

67. A log splitter as claimed in claim 58 in which the urging means is operably coupled between the mounting means and the support element, and preferably, the urging means comprises a secondary hydraulic ram.

68. A log splitter as claimed in claim 58 in which the anvil adjacent the leading edge thereof tapers towards the leading edge for engaging between a log and a surface on which the log is supported, and preferably, the anvil defines an inner major surface facing towards the splitting element, and an opposite outer major surface facing away from the splitting element, the outer major surface being chamfered adjacent the leading edge of the anvil to form the tapering portion of the anvil adjacent the leading edge.

69. A log splitter as claimed in claim 58 in which a projecting element extends sidewardly from the anvil adjacent one side thereof for engaging and manoeuvring a log, and preferably, the projecting element tapers towards a distal end thereof.

70. A log splitter as claimed in claim 58 in which a support member is provided extending sidewardly from at least one side of the support element for supporting a log in the log splitter when the log splitter is oriented with the open mouth defined between the splitting element and the anvil facing in a generally upwardly direction, and preferably, a pair of support members are provided on respective opposite sides of the support element, and advantageously, each support member is releasably coupleable to the support element, and preferably, each support member is mounted on a framework which is releasably coupleable to the support element.

71. A log splitter as claimed in claim 58 in which a manual control means is provided for manually controlling the drive means, and preferably, the manual control means comprises a safety interlock system, the safety interlock system being configured so that the two hands of an operator are required to manually operate the drive means through the manual control means.

72. A log splitter as claimed in claim 58 in which the distance of travel of the moveable one of the splitting element and the anvil from the other one of the splitting element and the anvil to the receiving state is selectable.

73. A working arm of a prime mover, the working arm comprising the log splitter as claimed in claim 58, the log splitter being coupled to the working arm by the mounting means, and advantageously, the working arm terminates in a coupling element, and the mounting means is coupled to the coupling element, and preferably, the mounting means is releasably coupleable to the coupling element, and advantageously, the coupling element is pivotally coupled to the working arm, and is pivotal about a coupler axis relative to the working arm, the coupler axis extending in a direction substantially perpendicular to the main pivot axis and substantially parallel to the leading direction from which the anvil extends from the support element, and preferably, the working arm comprises a dipper arm, and the coupling element is pivotally coupled to the dipper arm about the coupler pivot axis.

74. A prime mover comprising a working arm as claimed in claim 73, and preferably, the drive means and the urging means of the log splitter are powered by an on board power system of the prime mover.

75. A method for splitting a log, the method comprising providing a log splitter as claimed in claim 58, coupling the log splitter to a working arm of a prime mover by coupling the mounting means to a coupling element of the working arm, operating the working arm for urging the log splitter towards a log to be split until the log is located in the open mouth defined between the splitting element and the anvil, and operating the drive means of the log splitter for urging the moveable one of the splitting element and the anvil from the receiving state to the splitting state for splitting the log.

76. A method as claimed in claim 75 in which the urging means of the log splitter is operated for pivoting the support element about the main pivot axis relative to the mounting means to orient the open mouth defined between the splitting element and the anvil to face towards a log to be split, and preferably, the urging means of the log splitter is operated for pivoting the support element about the main pivot axis relative to the mounting means for configuring the anvil for engaging beneath the log and between the log and the surface on which the log is supported, and advantageously, the urging means of the log splitter is operated for urging the support element from one of the first state and the second state to one of the intermediate states for configuring the anvil for engaging beneath the log between the log and the surface on which the log is supported.

77. A method as claimed in claim 75 in which the coupling element of the working arm is pivoted about the coupler pivot axis relative to the working arm for orienting the log splitter with the open mouth defined between the splitting element and the anvil facing in a generally upwardly direction for facilitating manual feeding of a log into the open mouth defined between the splitting element and the anvil, and preferably, the drive means of the log splitter is manually controlled when the log splitter is oriented with the open mouth defined between the splitting element and the anvil facing in a generally upwardly direction.
